(19) United States
(12) Patent Application Publication
(10) Pub. No.: US 2023/0214094 A1
(43) Pub. Date: Jul. 6, 2023

(54) METHODS AND APPARATUS FOR RELATED SEARCH WITHIN A BROWSER

(71) Applicant: GOOGLE LLC, Mountain View, CA (US)

(72) Inventors: Yana Yushkina, Seattle, WA (US); Nicholas Sexton, Brooklyn, NY (US); Samuel Birch, Seattle, WA (US); Filip Jerzy Gorski, Sammamish, WA (US); Theresa Marie Sullivan, Los Gatos, CA (US); Ayman Almadhoun, Seattle, WA (US); Donn Locke Denman, Los Gatos, CA (US); Gang Wu, Bellevue, WA (US); Krishnan R. Subramaniam, San Francisco, CA (US); Bharath Santosh, San Jose, CA (US); SM Shabab Hossain, San Bruno, CA (US); Sheng Wang, San Jose, CA (US); Damon Chizu Kawamoto, Santa Cruz, CA (US); Tina Lin Zeng, Montebello, CA (US)

(21) Appl. No.: 18/067,532

(22) Filed: Dec. 16, 2022

Related U.S. Application Data
(60) Provisional application No. 63/266,294, filed on Dec. 31, 2021.

(51) Int. Cl. G06F 3/0483; G06F 3/0482; G06F 16/9538

(52) U.S. Cl. CPC G06F 3/0483; G06F 3/0482; G06F 16/9538

(57) ABSTRACT

A device may, in response to selection of a search area included in a webpage displayed within a display area of a browser: request a search for content of the search area, receive a searched query, a search result page for the searched query, and a related search request, and cause display of a first search request indicator and a second search request indicator within a search result area outside of the display area and within the browser. A device may receive a selection of the first search request indicator. A device may, in response to the selection of the first search request indicator, cause display of content for the first search request indicator within a navigation area of the search result area.

### CROSS-REFERENCE TO RELATED APPLICATION

This application is a non-provisional of, and claims the benefit of, U.S. Provisional Patent Application No. 63/266,294, filed on Dec. 31, 2021, entitled “METHOD AND APPARATUS FOR RELATED SEARCH WITHIN A BROWSER,” the disclosure of which is incorporated by reference herein in its entirety.

### BACKGROUND

A web browser can be used to display content that is searched via a search engine. Content can be displayed within the web browser in response to selection of one or more of the search results by a user.

### SUMMARY

In one general aspect, a method can include triggering a search query of the search area and causing display of a search result area that overlays the display area (e.g., content window, tab content window) of the browser. The search result area represents a window (area) outside of the display area but still within the browser. The search request area, including one or more related searches displayed as search request indicators can be generated in response to selection of a search area included in a webpage displayed within a display area of a browser. The search result area may include a query determined for (a search performed for) the search area. The search result area can include one or more related search requests (i.e., related queries), for the determined query. In some implementations, the search result area can include text that identifies the query determined for the search area. The one or more related search requests may be represented in the search result area by search request indicators, e.g., a first search request indicator and a second search request indicator within the search result area. In some implementations, the determined query may be represented by one of the search request indicators. The search result area can include a navigation area where a search result page is displayed and can be interacted with. Interaction with (selection of) a search request indicator can change the content of the navigation area without changing the search request indicators.

### BRIEF DESCRIPTION OF THE DRAWINGS

FIGS. 1A through 1E are diagrams that illustrate rendering of content within a display area, a search result area, and a navigation area of a browser, according to an implementation.

FIGS. 2A through 2C are diagrams that illustrate another implementation related to rendering of content within a display area, a search result area, and a navigation area of a browser, according to an implementation.

FIGS. 3A through 3D are diagrams that illustrate another implementation related to rendering of content within a display area, a search result area, and a navigation area of a browser, according to an implementation.

FIG. 4 is a diagram that illustrates a computing system and search server for implementing the concepts described herein.

FIGS. 5A and 5B are flowcharts illustrating an example process for rendering of content within a display area, a search result area, and a navigation area of a browser, according to an implementation.

FIG. 6 is a flowchart illustrating an example process for determining related search requests for a search of selected content within a display area, according to an implementation.

FIG. 7 shows an example of a generic computer device and a generic mobile computer device, which may be used with the techniques described herein.

### DETAILED DESCRIPTION

This disclosure is related to navigation of content associated with search results (or indicators thereof) retrieved in response to a selected search area. More specifically, this disclosure relates to providing a searched (main) query and one or more additional related search queries (related search requests) for a search area. The search area represents content of a webpage selected by a user of a browser. The search area can represent non-anchor text, or in other words, text that is not part of a link. In some implementations, the searched query and the one or more related search requests can be represented as actionable search request indicators in a search result area. In some implementations, the one or more related search requests can be represented as actionable search request indicators but the searched query is not represented as an actionable search request indicator in the search result area. The search result area may overlay (obscure, displace) the webpage from which the search area was selected. Upon selection of the search area, the browser may initiate a request for a search of the selected text. As part of the request for the selected text, the browser may also provide an identifier (e.g., location, URL, URI, etc.) for the webpage, context for the selected text, and/or a quantity of related queries (related search requests) to include in the response to the request. The search server may determine a query for the search area. This query selected by the search server is referred to as the searched query or the main query. The search server may also provide a number (e.g., one, two, etc.) of related queries. The related queries represent other queries that were not searched but are also relevant to the search area. In some implementations, the search server may use the webpage identifier and the number of (quantity of) related queries to rank and select related queries. In some implementations, no more than the requested quantity of related queries are returned. In some implementations, related queries that have fewer characters are favored in the ranking. The search server may provide the searched query, a search result page for the searched query, and one or more related queries in a response to the request that is provided to the browser.

The response provided by the search server to the browser is thus related to a search area selected from content within a webpage. The content can include all of the text visible to the user, and can extend beyond what's visible. The selection of text that the user chooses can be prioritized in the consideration of appropriate related searches. The response can include a search result page. The response can include related search requests. The related search requests can be displayed within a search result area of the browser, so that the content of the webpage is maintained (e.g., persists) in the browser while a search result page and the related search requests are displayed. Also, the related search requests can be provided as interactive indicators (e.g., buttons, links, a selectable area/image, etc.), which are maintained (e.g., persist) in the search result area. At least one of the search requests (a search request indicator) can be selected, and content associated with selected search request (i.e., a search result page) can be displayed in the search result area while maintaining the webpage in the browser display area. In some implementations, the content associated with the search request (e.g., a search result page) can be presented in a new tab. The search request indicators can continue to be displayed (e.g., can be maintained, or can persist) even as the content of a navigation area of the search result area changes. Thus, the search request indicators enable navigation of the content without losing the context of the searched query. The browser can be referred to as a browser window when associated with a window of an operating system (OS).

A technical problem associated with content in a webpage, is that even after content to be searched within the webpage is identified, the content within the webpage may not be maintained during a search unless a separate browser, tab, or application is used. Where the user selects an area of the content, it also may not be apparent what search (query) the user intends, as some disambiguation is involved. For example, content within a webpage can be copied for searching, and the webpage can be replaced with a search engine interface, or a separate browser or tab can be used to search the content. Computing resources, such as memory, bandwidth, and battery, are consumed when the user submits multiple queries or must open new tabs to perform a search.

At least one technical solution to the technical problems described above is that a search result can be displayed within a search result area of the browser, along with related search requests so that the content of the webpage is maintained (e.g., persists) in the browser in a separate display area while the search results and related search requests are displayed. At least one technical effect of this technical solution is that the original webpage content is not lost while the search results are consumed. Another technical effect of this technical solution is that a user can submit additional queries to get additional search results while maintaining the original webpage content and maintaining the original search context (e.g., the searched query/main query). The related search requests can be selected to optimize the limited display area of a mobile device (e.g., smartphone, tablet, glasses, smartwatch, etc.) and minimize keystrokes and gestures for performing multiple searches. Thus, search results within a search result area and webpage content within a display area can be simultaneously displayed within the browser (e.g., within a tab of the browser) and multiple searches performed with minimal input from the user.

In some implementations, a search result area can be integrated as part of the browser so that the search result area may not be spoofed (e.g., imitated) by a third party or the owner of the webpage content. This can be implemented as a security feature so that a user can distinguish legitimate search results provided by a search query from search results that can be inserted by a third party or by the provider of the webpage. Accordingly, the technical problem of spoofing search results can be obviated by the technical solution of integrating a search result area within the browser as described above. The technical effect of integration of a search result area within a browser is that spoofing can be prevented.

As mentioned above, in some implementations, search results can continue to be displayed (e.g., can be maintained, or can persist) in a search result area even as the content of the search results are displayed. The content associated with the search results can be displayed within a navigation area simultaneously within the browser (e.g., within a tab of the browser). Accordingly, the technical problem of enabling to simultaneously navigate content associated with search results while viewing the search results in a search result area is solved by the technical solution and technical effect described above.

The implementations described herein enable improved guided human-machine interactions for viewing webpages on the one side and for performing different queries on the viewed webpages and displaying the respective search results on the other side. The viewing of the webpages and performing the queries with viewing their results is done simultaneously by using one user interface only. This saves processing resources for maintaining and managing different user interfaces required for viewing a webpage and then for performing queries on the webpage and viewing the respective query results. This also results in fewer interactions of the user with the user interface. Moreover, different queries may be executed with regard to a selected search area of the webpage and their results may be easily acquired and viewed by using one user interface only. Further, less communication between a browser and a server is required in the implementations described herein as, upon requesting a search for content of a search area of a web page, different request variants are considered at the server and the server provides to the browser data that relates not only to a searched (main) query but also to (possible) related search requests. The browser may handle the related search requests without requiring further extensive communication with the server. The user may easily switch between different requests and their results and view the webpage at the same time in the same interface. This improves the user's interaction with the web page.

The browsers described herein can be executed within a computing device. For example, the browsers can be executed within a laptop device. In some implementations, the browsers can be executed within a mobile device. Although many of the implementations shown and described herein are shown in portrait mode, any of the implementations described herein can be rendered in a landscape mode.

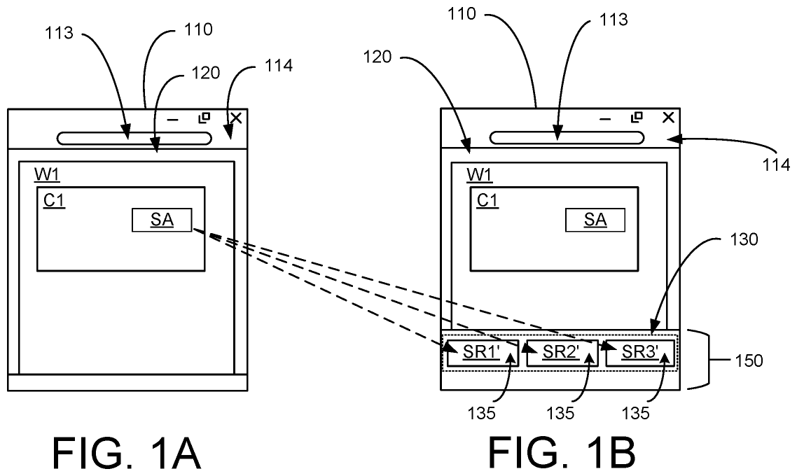

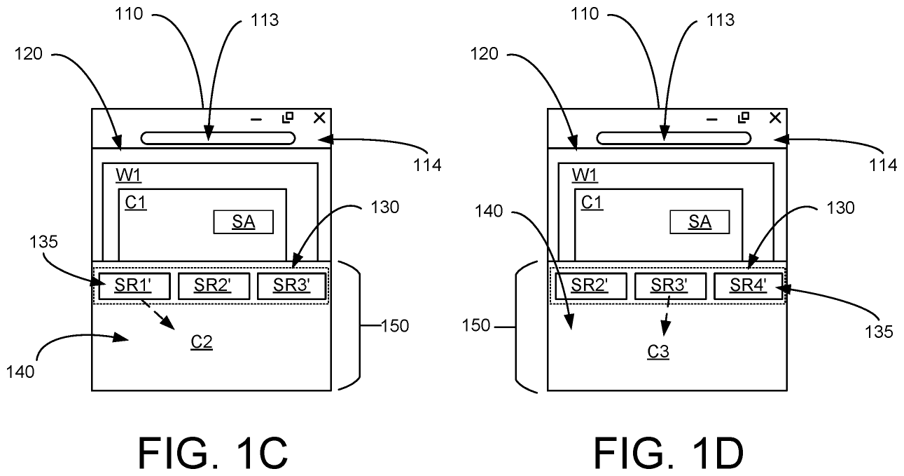

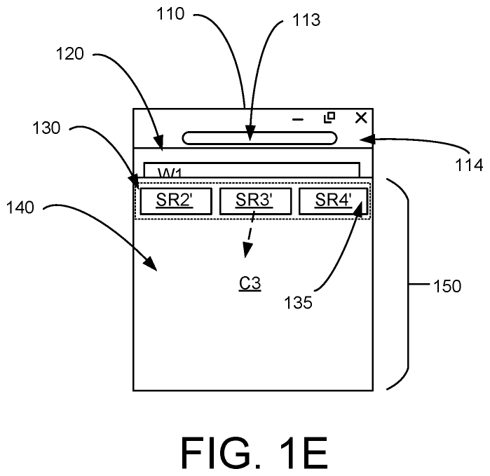

FIG. 1A is a diagram that illustrates a webpage W1 displayed within a display area 120 of a browser 110. In some implementations, the display area 120 can be within a tab of the browser 110. As shown in FIG. 1A, the webpage includes content C1. The content C1 can include image content, textual content, and/or so forth.

As shown in FIGS. 1A through 1E, the browser 110 includes an address bar area 114. An address (e.g., uniform resource locator (URL)) of the webpage W1 can be illustrated in the address bar area 114 (e.g., input address area 113). Other controls, icons, and/or so forth can be included in the address bar area 114. The address bar area 114 can be controlled by and/or associated with the browser 110 (e.g., the browser application). The address bar area 114 can be controlled by the browser 110 instead of the webpage W1 and/or a provider of the webpage W1.

FIG. 1B is a diagram that illustrates a search result area 150 that includes a search request area 130 (shown by a dashed box) triggered for display within the browser 110. The search result area 150 can also be referred to as an overlay area or an overlay window. The search result area 150 (overlay window) can include a search request area 130 and a navigation area 140. The search result area 150 in FIG. 1B can be triggered in response to receiving a search area SA (e.g., text, image) of the content C1. The search area SA can also be referred to as a search area SA of the webpage W1. The search area SA in FIG. 1A may be received in response to being selected (e.g., interacted with). In some implementations, an interaction can include a selection. In some implementations, an interaction (selection) may occur on a portion of the search area.

In some implementations, an interaction and/or selection (or an indication thereof) can be used to trigger an action or result. For example, in this implementation shown, search result SA can be selected in FIG. 1A. In response to the selection of search area SA in FIG. 1A, while the webpage W1 is displayed within the display area 120 in FIG. 1B, the browser may initiate a search request for the search area SA in FIG. 1A. In some implementations, the request for the search is triggered when the search area SA is or includes text. In some implementations, the request for the search is triggered when the search area SA is or includes an image. In some implementations, the request for the search is triggered when the selection area SA is not identified as actionable by the webpage W1. Content of a webpage is actionable when the webpage includes markup tags that pair selection of the content with an event. Anchor tags, tags with an onclick mouse event, etc., are examples of content that is actionable by the webpage W1. In other words, text or images that are already actionable (e.g., actionable text, actionable images) in the webpage W1 may be selectable to perform that action, such as navigating to another webpage W1 or initiating an action defined by the webpage W1. Content identified as actionable by the webpage may perform the action when selected and/or may, when selected/interacted with, cause display of a pop-up menu that includes the action identified by the webpage W1 and/or other actions to perform (e.g., a pop up window that asks if the content associated with a link should be opened in a new tab, in a new browser window, the link copied to a clipboard, the link opened in an incognito window, etc.). When content is identified as actionable by the webpage W1, the browser may not automatically override that action by automatically submitting a request for a search of the search area. In some implementations, the request for a search can be an option in the pop-up menu. When content is not identified as actionable and is interacted with (e.g., selected) by the user, the browser may automatically, i.e., without further interaction from the user, submit a request to search the content represented by the search area. The search request can be triggered by a user of, for example, a mobile device via a search of the content in the search area SA (e.g., a text search, an image search, and/or so forth). In some implementations, the request for the search can be triggered in response to the selection of the search area SA being completed. In some implementations, the request for the search (which is based on the search area SA) can be triggered in response to a long press selection (e.g., selection of the search area for a threshold period of time) of the search area SA. In some implementations, a user interface for triggering the search query based on search area SA can be used.

The search request includes content of the search area. The content of the search area may include at least one of the following: text or one or more images. The search request can include an identifier for the webpage W1 (e.g., an address, such as a URL or URI). The search request can include context from the content C1 of the webpage W1. The context can include text located near the search area SA (e.g., within a number of words before and/or after the search area, within a number of pixels, within a DOM node with, etc.). The search request can include a quantity (number) of related queries to return. In other words, the browser can, as part of the request, tell the server how many related queries to provide in the response. The browser may send the search request to a server, e.g., a search server.

The search server receives the search request from the browser and determines a query for the content of the search area. The search server can use conventional techniques (e.g., natural language processing, entity identification, etc.) to determine the query. In some implementations, the search server may use the context, if provided, in determining the query. In some implementations, the search server may use the webpage identifier to determine the query. The query can comprise text, e.g., a word, a phrase, an acronym, etc. The text may include text identified in the (content of) the search area. The text may include text identified using the context. The text may include text using entity identification. The query can comprise an entity identifier. Where the search area includes an image, the query can comprise an image. The search server may generate a search result page for the query. Thus, the query determined by the search server for the search area may be referred to as a searched query or the main query. A search result page is a webpage generated by the search server in response to a query. A search result page includes a plurality of search results. A search result can be associated with an identifier for a resource that is considered responsive to the query. Thus, a search result can represent the resource. A resource can be any content accessible via the Internet, e.g., a webpage, a PDF file, an audio file, an image, a video file, a document, etc. A resource is accessible via an identifier, such as a URL, URI, etc. A search result includes a link to the resource, the link using the resource identifier. A search result can include text from the linked-to resource, e.g., a webpage title, a snippet (text extracted from the content of the resource), etc. A search result can include an image from the linked-to resource. A search result can be a rich answer, such as a knowledge panel, a short answer (e.g., a definition, an answer provided by a third-party app and triggered by queries that match a particular type of query), etc. The search result page can include other elements, such as advertisements, “people also asked” short answers, interactive rich answers, links for refining the query, etc., as is known.

The search server may also determine related queries for the searched query. In some implementations, the related queries can be generated based on the search area SA, i.e., the content of the search area. In some implementations, the related queries can include queries considered for the searched query but not selected as the searched query. In other words, the related queries can be lower-ranked queries considered, but not selected as, the searched query. For example, where the content of the search area includes an ambiguous entity reference, the related queries can include a second entity where the first entity is selected as the searched (main) query. In some implementations, the related queries may be queries frequently (e.g., as determined by statistical analysis) submitted after the searched (main) query. In some implementations, the related queries can be generated based on the identifier (e.g., URL) for the webpage associated with the search area SA. For example, in some implementations, the related queries can include a query for which the webpage is a top-ranked resource. As another example, the related queries can include a query frequently submitted before a user navigates to the webpage. As another example, the identifier may be used to identify queries that have responsive documents, including the document identified by the identifier, with shared passages.

The related queries can also be referred to as related search requests. Potential (or candidate) related queries can be generated using conventional techniques. The search server may select some of the potential related queries to provide as part of a response to the search request. The search server may rank the potential (candidate) queries to identify selected related queries. If a quantity of related queries is provided to the search server as part of the search request, the search server may select that quantity of top-ranked related queries to return as part of a response to the search request. The search server can rank the related queries using conventional ranking factors. The search server can also use the location for the webpage W1 to rank the related queries. The location of the webpage is not a conventional ranking factor for related queries because a webpage is not associated with search engine queries. Ranking factors include, e.g., semantic proximity of the suggestion to the highlighted text and how many times the suggestion follows the highlighted text.

In some implementations, the search server may use the length (in characters) of a related query as a ranking factor. For example, related queries that are too long may be downranked because these related queries take up too much area on the display of the client. Thus, the search system may prefer shorter related search requests (shorter related queries) over longer related search requests (longer related queries). The search server may send a response to the search request back to the browser. The response can include the searched query, the search result page for the searched query, and at least one related search request (related query). In some implementations, no more than the requested quantity of related search requests are provided as part of the response to the search request.

In response to receiving the search request response, the search result area 150 is rendered within the browser 110 in FIG. 1B. The search result area 150 includes search request area 130. In some implementations, the search result area 150 overlays the display area 120. In some implementations, the rendering of the search result area 150 causes the display area 120 to shrink in size. In either implementation, in response to the selection of search area SA in FIG. 1A, both the webpage W1 is displayed (i.e., within the display area 120) and the search result area 150 is rendered within the browser 110 in FIG. 1B. Thus, while both the search result area 150 results and the webpage W1 are visible, rendering of the search result area 150 may decrease the amount of content of the webpage W1 visible in the display area 120.

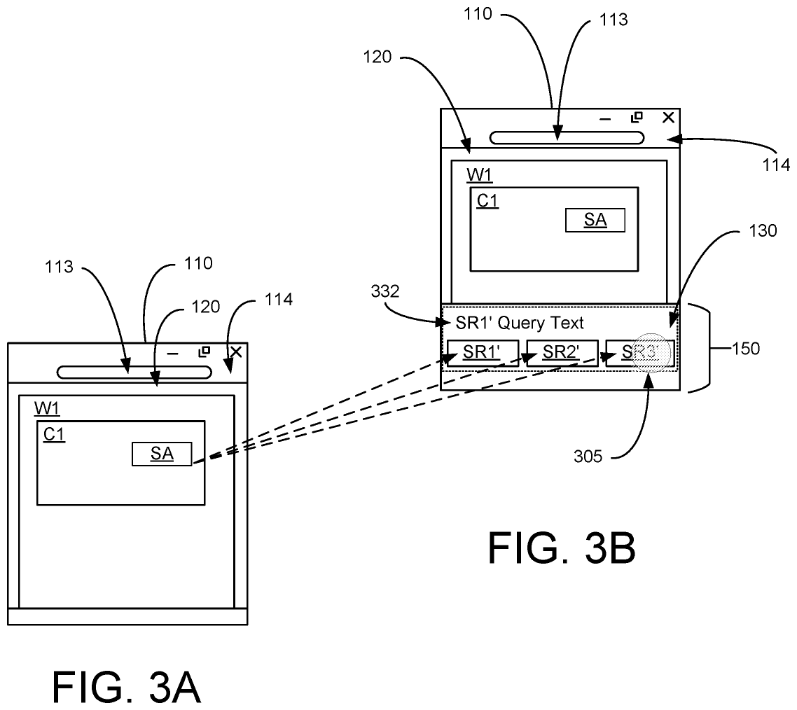

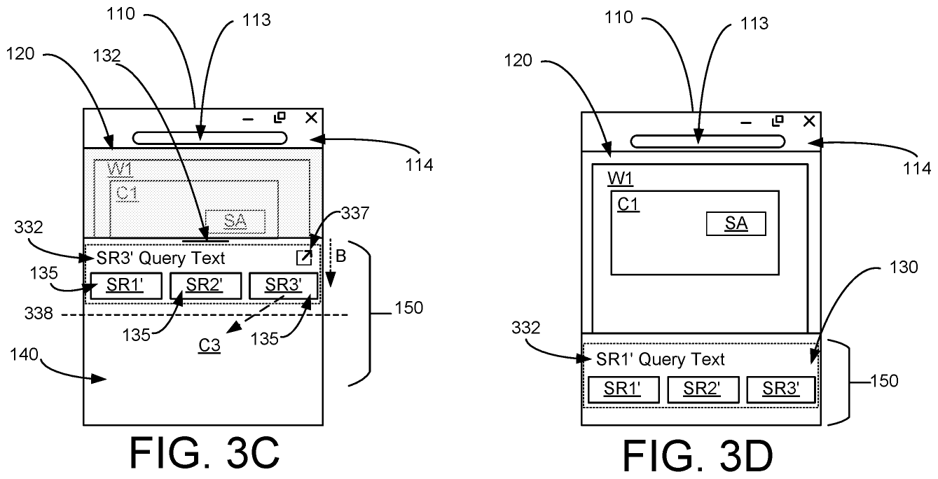

As shown in FIG. 1B, the search result area 150 can include search request area 130. The search request area 130 includes search request indicators 135, labeled SR1′ through SR3′ in FIG. 1B. Thus, the search request indicators SR1′ through SR3′ can collectively be referred to as search request indicators 135. The search request indicators SR1′ through SR3′ can represent at least some of the related queries (related search requests) provided in the response from the server (other related queries provided may be associated with search request indicators that are not displayed in the search result area 150 but can be accessed via scrolling). The search request indicators 135 can be interacted with to request searches related to the search area SA. Thus, the search request indicators 135 represent actionable user interface elements. An actionable user interface element can be interacted with by the user to perform a programmed action. The action performed by a search request indicator 135 is submission of a search request to the search server, e.g., in the form of a query. A search request indicator can thus be associated with (generated for) one of the related search requests provided by the server. In some implementations, one of the search request indicators can be associated with (generated for) the searched query (the main query). The related search requests (e.g., related queries) can include a word (keyword), a phrase, and/or multiple words or phrases, e.g., so that interaction with a search request indicator requests a search for the word, phrase, etc. The related search requests can include/be an image, e.g., so that interaction with the search request indicator for the related search request requests a search for the image. The related search requests are provided by the search server as part of the response to the request to search the selected area SA. In some implementations, a first search request, e.g., a search request submitted in response to interaction with SR1′, is the searched query (the main query) and a second search request, e.g., a search request submitted in response to interaction with SR2′, is the related search request (the related query) provided by the server. In some implementations, the searched query is not represented by (associated with) a search request indicator. In such implementations, the searched query may be represented in a query text area of the search result area 150 (e.g., as discussed with regard to FIGS. 3A-3D) and the first search request, e.g., a search request submitted in response to interaction with SR1′, and the second search request are each for a different related search request provided by the server.

In some implementations, one or more of the search request indicators 135 can include text. In some implementations, one or more of the search request indicators 135 can include images. The search request indicators 135 can include or can be a keyword/keywords that can be selected for retrieval of additional content (e.g., additional search result pages). Thus, additional search results can be navigated via the search request indicators SR1′ through SR3′. In other words, the search request indicators SR1′ through SR3′ can be interacted with to provide additional search results (e.g., via different search result pages), enabling a user to navigate to different search result content (different search result pages) without navigating away from the search result area 150 or the webpage W1.

In some implementations, the search request indicators SR1′ through SR3′ may represent a subset of related queries surfaced in response to the search request for the search area. In some implementations, the search request indicators SR1′ through SR3′ can be a rank-ordered (e.g., highest ranked) subset of related queries surfaced in response to the search request for the search area. In some implementations, one or more of the search request indicators SR1′ through SR3′ can be prioritized so that the most relevant related searches (or a subset thereof) are rendered within the search request area 130. The prioritization is based on a ranking order determined by the server. In some implementations, the searched query represents a highest-ranked search for the search area.

In some implementations, although not shown in FIG. 1B, additional search request indicators 135 can be surfaced in response to a search request for the search area SA. The additional search request indicators 135 may be viewed by scrolling through, or otherwise navigating through, the search request area 130. For example, the search request area 130 may include a carousel of search request indicators 135. Accordingly, the additional related search requests can be viewed within the search request area 130. For example, in some implementations, the additional search request indicators 135 can be viewed by scrolling left and right within the search request area 130.

As shown in FIG. 1B, in response to the search result area 150 being rendered, the size (e.g., a visible area) of the display area 120 (shown in FIG. 1A) is decreased. In other words, the visible portion of the display area 120 is decreased in size in response to the search result area 150 being displayed. In some implementations, the search result area 150 is an overlay, e.g., appears on top of the display area 120. Thus, in some implementations, the search result area 150 can overlap with the webpage W1 without modifying the scale of the webpage W1 (e.g., partially overlay the webpage W1). In some implementations, the webpage W1 can be modified (e.g., scaled) in layout to fit (e.g., fit for display) into the display area 120. In some implementations, the display area 120 shown in FIG. 1A can be divided into the display area 120 and the search result area 150 as shown in FIG. 1B. The combined areas of the display area 120 and the search result area 150 shown in FIG. 1B can be the same as the area of the display area 120 as shown in FIG. 1A. In some implementations, the combined areas of the display area 120 and the search result area 150 can be different from (e.g., smaller than, larger than) the area of the display area 120.

In some implementations, any background or theme applied to the address bar area 114 can flow into (and would be contiguous with) the search result area 150. The contiguous background would be difficult for a third party (e.g., provider of the webpage W1) to imitate within an application of the browser 110. Moreover, the contiguous background or theme can be implemented as a security feature so that a user can distinguish legitimate search results provided by a search query from search results that can be inserted by a third party or by the provider of the webpage.

FIG. 1C illustrates content C2 (e.g., a search result webpage) rendered in a navigation area 140 within the search result area 150. The content C2 can be rendered in the navigation area 140 in response to an interaction (e.g., a user interaction) with the search request indicator SR1′ in the search request area 130. The navigation area 140, in this implementation, does not replace the display area 120. The content C2 displayed in the navigation area 140, in this implementation, is visible even while the webpage W1 (and content C1) is at least partially displayed in the display area 120. The search request area 130 with the search request indicators 135 are disposed between the navigation area 140 and the display area 120. In some implementations, the content C2 is populated without interaction with the search request indicator SR1′. For example, where the search request indicator SR1′ represents the searched query, the browser may populate (pre-load, pre-render) the navigation area 140 with the search result page returned in response to the request to search the search area. In such an implementation, the content C2 can be viewed without selection of the search request indicator SR1′. For example, a user may drag the top portion of the search result area 150 toward the display area 120 to view at least a portion of the content C2. The content C2 could also be viewed by maximizing the search result area 150. Maximizing the search result area 150 can be done, for example, by dragging a top portion of the search result area 150 toward the display area 120. Maximizing the search result area 150 can also be done, for example, in response to selection of one of the search request indicators 135. When the search result area 150 is in a maximized state it occupies more area than display area 120 but does not fully cover/overlay the display area 120.

The navigation area 140 can be used to consume (e.g., explore) the search results for the currently selected search request, i.e., the related search request represented by the most recently selected search request indicator of the search request indicators 135. The searched query is considered the currently selected search request before any of the search request indicators 135 are selected. For example, in response to a first search request indicator being selected from the search request area 130, first content can be rendered in the navigation area 140. In response to a second search request indicator being selected from the search request area 130, second content can be rendered in the navigation area 140 instead of, or in addition to, the first content. The content can be navigated while the search results (e.g., search request indicator SR1′) is maintained within the search request area 130.

Although not shown in FIG. 1C, in some implementations, the search request indicator SR1′ is not displayed within the search request area 130 because the content C2 corresponding to the search request indicator SR1′ is already displayed. Accordingly, the search request indicator SR1′ associated with content already displayed in the navigation area 140 may not be included in the search request area 130. In some such implementations, text (or an image) corresponding to the search request indicator SR1′ may be provided in a query title area of the search result area 150, as discussed with regard to FIG. 3B.

Although not shown in FIG. 1C, in some implementations, interaction with (e.g., selection of) at least a portion (e.g., a link) of the content C2 while the search request area 130 is shown can result in the search request area 130 being closed and a new browser tab opened. For example, selection of a link in the content C2 can cause the resource (e.g., webpage, file) associated with the link to open in a new tab of the browser. As another example, the display area 120 can be removed and the resource associated with the link can be expanded into the current tab (e.g., the entirety of the display area 120 of the browser 110) in response to selection of a link in the content C2. This can result in the search result area 150 being closed. As another example, selection of a link in the content C2 can also cause display of a menu (e.g., a pop-up menu) with options for opening the resource associated with the link. In some implementations, although not shown in FIG. 1C, interaction outside of the search result area 150 can result in the search result area 150 being closed.

FIG. 1D illustrates content C3 (e.g., content of a search result page) rendered in a navigation area 140 within the search result area 150 of the browser 110. The content C3 is rendered in the navigation area 140 in response to an interaction (e.g., a user interaction) with the search request indicator SR3′ in the search request area 130. The navigation area 140, in this implementation, replaces the content C2 within the navigation area 140. The content C3 displayed in the navigation area 140, in this implementation, replaces the content C2 displayed in the navigation area 140. As shown in FIG. 1D, the search request indicators 135 are shifted so that the search request indicator SR3′ corresponding with the content C3 is more centered within the search request area 130. Also, in FIG. 1D, search request indicator SR4′ is shown because search request indicator SR3′ is shifted. Search request indicator SR4′ may have been viewable via a scrolling input (e.g., right-to-left swipe or drag) in the search request area 130 prior to selection of the search request indicator SR3′.

Further to the implementation shown in FIGS. 1A through 1D, in some implementations, a new web address can be input into input address area 113 of the address bar area 114 after the search request area 130 and the navigation area 140 are defined. In response to the new web address area, a different webpage (not shown) can replace the webpage W1 (or other content) in the navigation area 140, while maintaining the search request indicators 135 in the search request area 130. In other words, the search request indicators 135 can be maintained even while navigating within the navigation area 140 and using a different web address in the address bar area 114 of the browser 110.

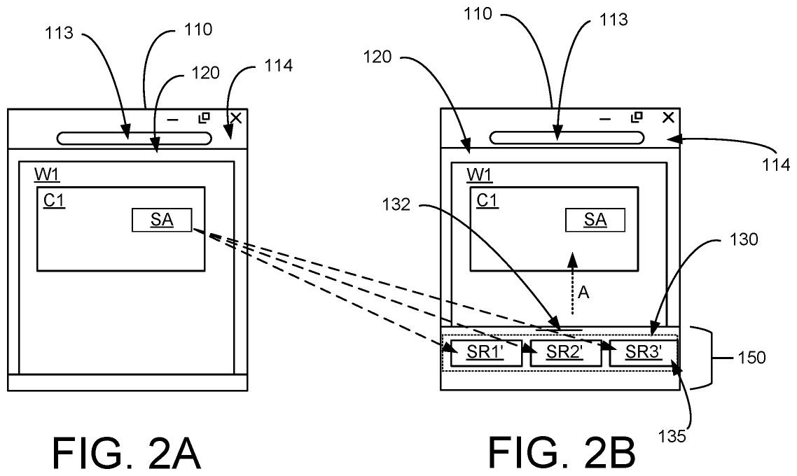

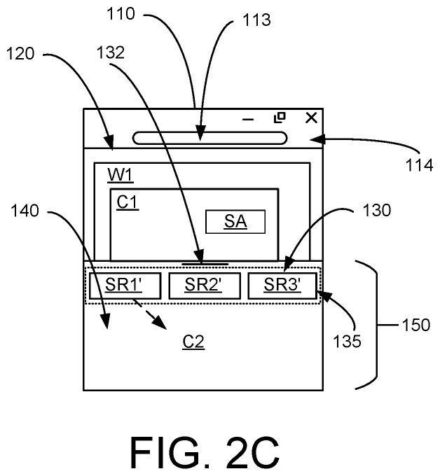

FIG. 1E illustrates that the navigation area 140 can be changed (e.g., increased, decreased) in size. In FIG. 1E, the navigation area 140 is increased in size relative to the size of the navigation area 140 shown in, for example, FIG. 1D. In some implementations, a handle (not shown) or other icon associated with, or included in, the navigation area 140 can be used to pull, or push, the navigation area 140 so that it can be changed in size. For example, a handle can be selected and dragged to change a size of the navigation area 140. An example handle 132 is illustrated in at least FIGS. 2B and 2C.

In some implementations, a user interface element (e.g., a back button, a back arrow) can be used to remove (e.g., clear, navigate away from) content rendered in the navigation area 140 (e.g., the webpage W2). In some implementations, the user interface element can be used to remove (e.g., clear) the search request area 130 and/or the navigation area 140. In some implementations, the user interface element can be used to navigate away from (e.g., backward from) the webpages (e.g., webpage W2), the search request indicators 135, and/or the search result area 150.

FIGS. 2A through 2C illustrate an alternate display implementation associated with the display area 120 and the search result area 150 (search request area 130 and navigation area 140). In some implementations, content C2 associated with search request indicator SR1′ is shown in response to the navigation area 140 being expanded in size. For example, the search request indicators SR1′ through SR3′ can be rendered in search request area 130 in FIG. 2B in response to a selection of search area SA in FIG. 2A. A handle 132 (represented by a line) associated with search request area 130 can be selected and used to move (e.g., drag) the search request area 130 in an upward direction (illustrated by direction A) to reveal (e.g., to generate) the navigation area 140, as illustrated in FIG. 2C. In some implementations, in response to the movement of the search request area 130 to reveal the navigation area 140 content C2 associated with the search request indicator SR1′ (which is the first search request indicator) can be rendered. In some implementations, content associated with at least one of the search request indicators 135 that is in focus (e.g., centered within the search request area 130, also referred to as the currently selected search request) can be rendered within the navigation area 140 in response to movement of the search request area 130 (e.g., movement of the handle 132).

The location and/or shape of the search result area 150 (search request area 130 and/or associated navigation area 140) can be different than shown herein. In some implementations, the search request area 130 and/or associated navigation area 140 can be smaller in size than shown. In some implementations, the search request area 130 and/or associated navigation area 140 can be included along a different side of the browser 110 (e.g., along a bottom portion, along a top portion, along the left side, and/or so forth). In some implementations, the search request area 130 (and/or associated navigation area 140) can float above (e.g., can be rendered in a window above) the display area 120 so that the display area 120 in FIG. 1A is not decreased in size to the area of the display area 120 shown in FIG. 1B. In some implementations, the search request area 130 can be a different shape (e.g., a circular shape) rather than a square or rectangular shape.

As shown herein (e.g., FIG. 2C), the search request indicators 135 of SR1′ through SR3′ are arranged horizontally within the search request area 130 and can be navigated along a horizontal direction. In some implementations, the search request indicators SR1′ through SR3′ can be arranged within the search request area 130 in a different orientation (e.g., vertically).

FIGS. 3A through 3D illustrate an alternate display implementation associated with the display area 120 and the search result area 150 (search request area 130 and navigation area 140). In the example of FIGS. 3A through 3D the search result area 150 includes a query text area 332. The query text area 332 corresponds to the currently selected search request, or in other words, the search request in focus. The search request in focus corresponds to the searched query when the search result area 150 is initially displayed (rendered). The search request in focus can change based on interactions with the search request indicators 135. The search result page currently displayed in the navigation area 140 corresponds to the search request in focus. In the example of FIG. 3B, the search request indicator SR1′ corresponds to the searched query, so the query text area 332 includes text for the searched query. In the example of FIG. 3B, if a user changes the size of the search result area 150, e.g., as discussed with regard to FIG. 2C, the content of the navigation area 140 would be the search result page received for the searched query.

In some implementations, the query text area 332 display area can include an image associated with the search request in focus. In some implementations, the search server sends an image for the searched query in the response to the request to search the search area. The image may be small (sized to occupy an area similar to a few lines of text in the search result area 150) and may be displayed with text in the query text area 332 above the search request area 130. In some implementations, the image, if provided, is removed from the query text area 332 when the search result area 150 is maximized, conserving display area for additional content to be displayed in the navigation area 140. In some implementations, the text in the query text area 332 corresponds to the related search request/searched query.

FIG. 3C illustrates changes to the search result area 150 in response to an interaction 305 with the search request indicator SR3′. As illustrated, interaction with (e.g., selection of) the search request indicator SR3′ can cause the search result area 150 to change size. Thus, for example, the search result area 150 may be maximized, or in a maximized state in response to selection of the search request indicator SR3′. In addition, selection of the search request indicator SR3′ makes the related search request associated with SR3′ the currently selected search request, or in other words the search request in focus. Accordingly, the content of the query text area 332 is changed to correspond to the related search request associated with the search request indicator SR3′. In some implementations, when the search result area 150 is in the maximized state, a control 337 may be displayed. The control 337, when selected, may cause the browser to open the search result page for the search request in focus in a new tab or a new browser window. In some implementations, when the search result area 150 is maximized an appearance of the display area 120 may be modified. For example, as illustrated in FIG. 3C, the display area 120 may be shaded. In addition to causing the search result area 150 to be maximized, selection of SR3′ may submit a search request to the search server. The search request is a query that is represented by the related search request corresponding to SR3′. The search server may thus return a search result page that corresponds to SR3′ and display the search result page in the navigation area 140, e.g., content C3.

In the example of FIG. 3C, the user may decrease the size of the search result area 150, e.g., by interacting with handle 132. For example, the user may drag handle 132 in toward the navigation area 140, e.g., in the direction labeled B in FIG. 3C. In some implementations, once the handle 132 reaches a minimization threshold 338, e.g., represented by a dashed line in FIG. 3C, the browser may automatically change the currently selected search request, or in other words the search request in focus, to the searched query. Thus, for example, once the handle 132 reaches the minimization threshold 338 the browser may change the query text area 332 to the text for the searched query and may change the content of the navigation area 140 to the search result page for the searched query, as illustrated in FIG. 3D. The minimization threshold 338 may be a screen coordinate, e.g., a y-coordinate or an x-coordinate, that falls between the position of the handle 132 when the search result area 150 is in a maximized state and the position of the handle 132 when the search result area 150 is in a minimized state. The minimization threshold 338 may be closer to the position of the handle 132 when the search result area 150 is in the minimized state than to the position of the handle 132 when the 150 is in the maximized state. When the search result area 150 is in a minimized state, the search result area 150 may only display the search request area 130 and, in implementations that include it, the query text area 332. In other words, the navigation area 140 is not visible or is just barely visible when the search result area 150 is in the minimized state. Thus, for example, the search result area 150 of FIGS. 3B and 3D illustrate the search result area 150 in a minimized state and FIG. 3C illustrates the search result area 150 in a maximized state.

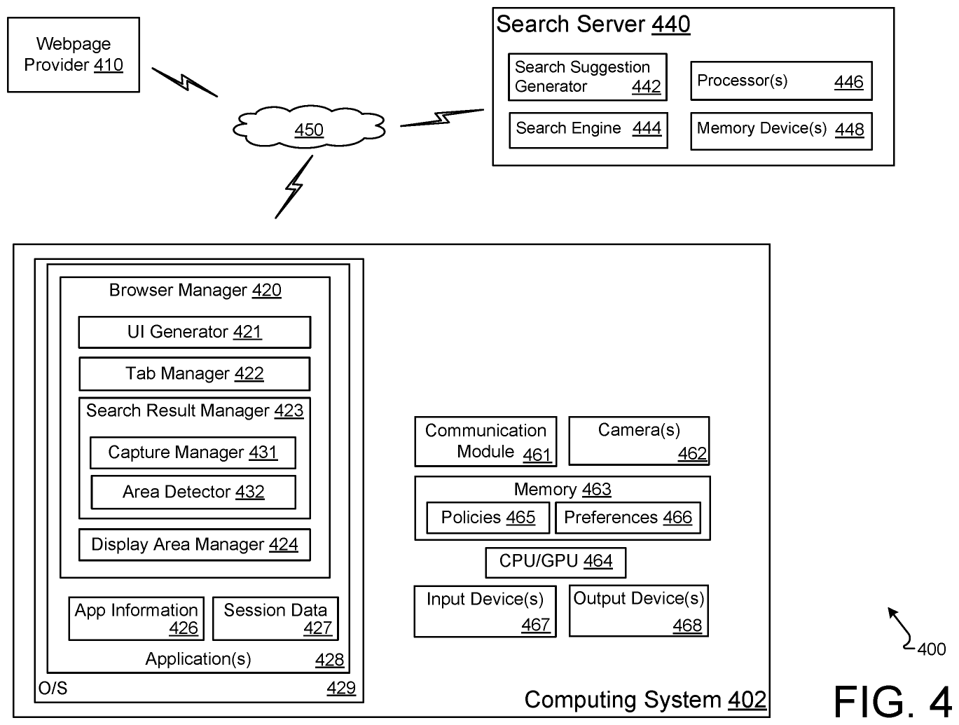

FIG. 4 illustrates a system 400 including a computing system 402 and a search server 440 configured for implementing the concepts and various implementations shown and described herein. As shown in FIG. 4, the computing system 402 is configured to communicate with the search server 440 and/or a webpage provider 410 (e.g., a web server) via a network 450. The computing system 402 includes at least a browser manager 420 and a search result manager 423. In some implementations, the browser manager 420 is configured to manage content, such as webpage content, provided by the webpage provider 410 (e.g., also referred to as a web server). In some implementations, the browser manager 420 is configured to operate as one of several applications 428 executed via an operating system (O/S) 429. The browser manager 420 can be configured to implement the key portions of the user interface, search results, windows, and/or so forth, as described in connection with the implementations described herein.

As shown in FIG. 4, the computing system 402 includes several hardware components including a communication module 461, one or more cameras 462, a memory 463, a central processing unit (CPU) and a graphics processing unit (GPU) 464, one or more input devices 467, and one or more output devices 468. The hardware components can be used to facilitate operation of the browser manager 420, the search result manager 423, and/or so forth of the computing system 402.

The browser manager 420 includes a user interface (UI) generator 421 configured to generate and/or manage the various user interface elements of a browser such as browser 110 as shown and described herein. For example, the UI generator 421 can generate UI elements including the various windows in the browser 110 such as the display area 120, the search result area 150, including the search request area 130, the navigation area 140, and/or the query text area 332, shown in at least FIGS. 1A through 1C and other figures.

The browser manager 420 includes a tab manager 422 configured to generate and/or manage the various tabs of a browser such as browser 110. The browser manager 420 may be configured to, amongst other things, open a new tab in response to interaction of the user with links in the search result page displayed in the navigation area (e.g., navigation area 140) of a search result area (e.g., search result area 150). The browser manager 420 may be configured to, amongst other things, open a new tab in response to interaction of the user with a control of the search result area 150 (e.g., control 337 of FIG. 3C). In some implementations, the control may be displayed when the search result area is displayed in a maximized state, as described herein.

The browser manager 420 includes a search result manager 423 configured to generate and/or manage content rendering such as content in the search result area 150, including the search request indicators, the content in the navigation area, the content in the query text area 332, etc. (as shown in at least FIG. 1B, 1C, 3B, 3C, and other figures). The browser manager 420 includes a display area manager 424 configured to generate and/or manage content rendering associated with a webpage W1 in the display area 120 (shown in FIG. 1B and other figures). The webpage W1 content can be provided to the computing system 402 by the webpage provider 410.

As shown in FIG. 4, session data 427 (which can be stored in memory 463 (not shown)) can be managed as, or by, one of the applications 428. The session data 427 can include data related to one or more browser sessions. The application information 426 can include information related to the various applications operating within and/or that can be executed by the O/S 429.

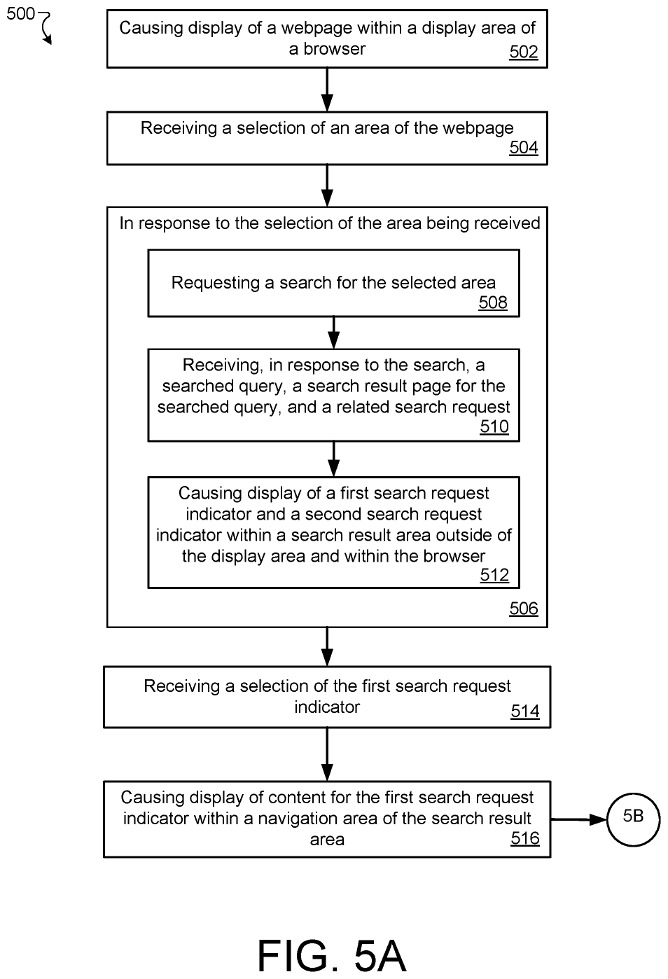

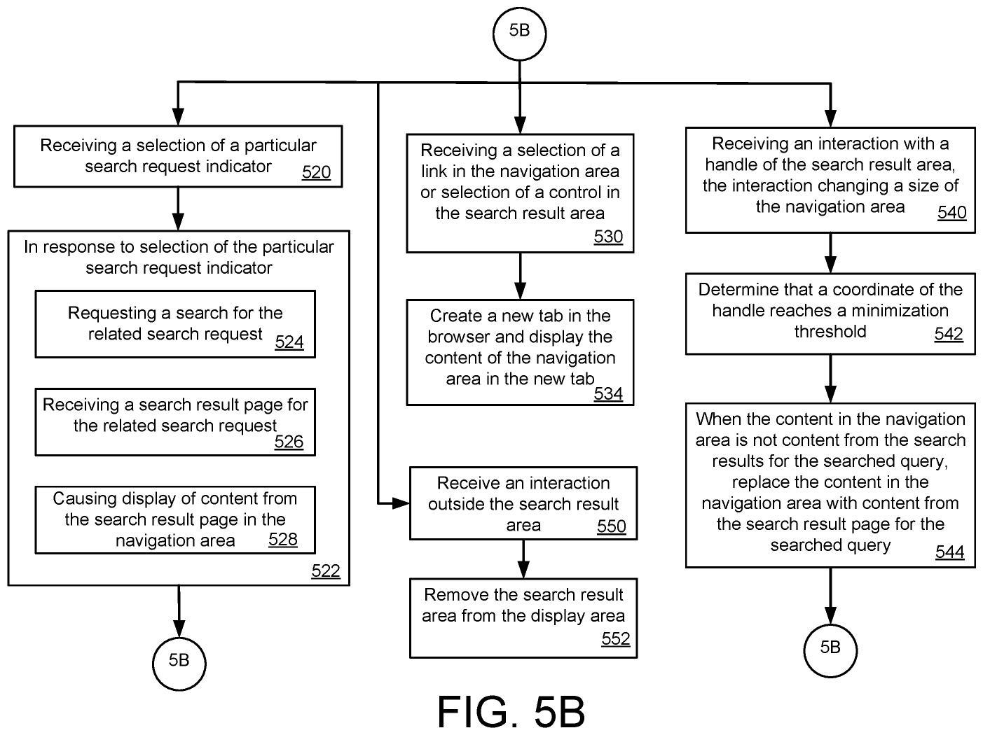

The search result manager 423 can also be configured to manage one or more elements selected for searching, e.g., search area SA of FIG. 1A and other figures. The search result manager 423 can trigger one or more search requests, e.g., generating a request for a search of a selected search area and sending the request to the search server 440. The search result manager 423 can include an area detector 432 that can detect one or more areas (e.g., search area SA shown in FIG. 1B and other figures) selected for searching. The search result manager 423 also includes a capture manager 431 that can manage content of search request, e.g., packaging the content of the search area, the identifier of the webpage, the context for the search area, and/or the number of related searches to return into a format expected by the search suggestion generator 442 of the search server 440. Selection of one or more areas for searching can be triggered by one or more input devices 467 (e.g., a mouse, a gesture, etc.) and can be communicated to the search result manager 423 (and area detector 432). The search result manager 423 can be configured to implement the process described in connection with FIGS. 5A and 5B.

As shown in FIG. 4, the communication module 461 can be configured to facilitate communication with the webpage provider 410 and/or search server 440 via the network 450 via one or more communication protocols. The camera 462 can be used for capturing one or more images, the memory 463 can be used for storing information associated with the browser manager 420 and/or search result manager 423, the CPU/GPU 464 can be used for processing information and/or images associated with the browser manager 420 and/or search result manager 423. The computing system 402 also includes one or more output devices 468 such as communication ports, speakers, displays, and/or so forth. The functionality described in this application can be implemented based on one or more policies 465 and/or preferences 466 stored in the memory 463, e.g., the number of related search requests to return etc.

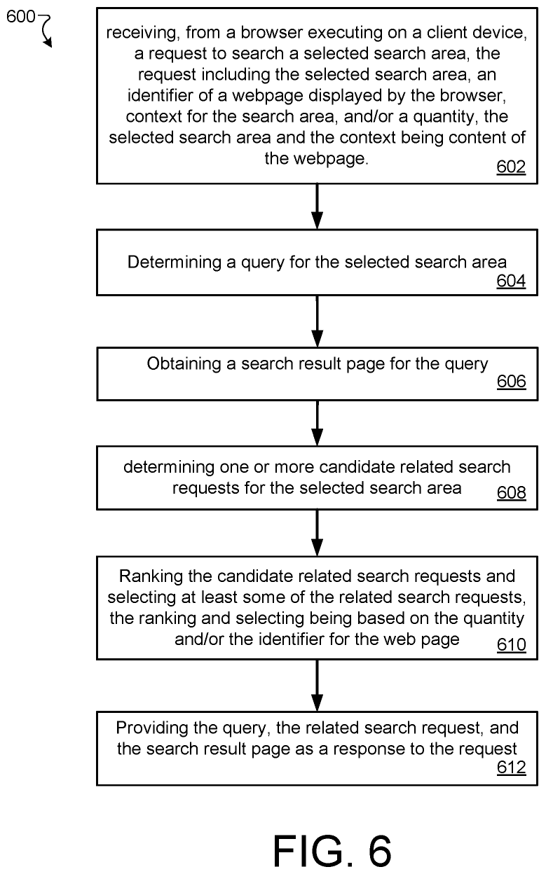

FIG. 4 illustrates some aspects of the search server 440. For example, the search server 440 includes one or more processors 446 and one or more memory devices 448. The search server 440 includes a search suggestion generator 442 configured to receive a request for a search of a search area from the computing system 402. A request for a search of a search area differs from a conventional search query because the query is not known ahead of time. The search suggestion generator 442 is configured to determine the searched query from the search area (optionally using the content of the webpage identified in the request to search the search area and/or the context provided with the request). The search suggestion generator 442 is also configured to identify candidate related queries for the search area, rank the candidate related queries, and select candidate related queries for inclusion in the response to the request. The search suggestion generator 442 may be in communication with a search engine 444 of the search server 440 (or a search engine 444 accessible to the search server 440). The search engine 444 may be used to provide a search result page for a query. For example, once the search suggestion generator 442 determines the searched query for the search area, the search suggestion generator 442 may send the searched query to the search engine 444, which may provide a search result page for the searched query. A search result page conventionally includes a plurality of search results, each result representing a resource considered responsive to the query. The search result page can also include rich results, such as short answers and/or knowledge panels. The search result page can also include advertisements or sponsored results. The search suggestion generator 442 can be configured to implement the process described in connection with FIG. 6.

FIGS. 5A and 5B are flowcharts that illustrate a method 500 of performing at least some of the concepts described herein in the various figures. Many elements of the method 500 can be implemented by the components shown in at least FIG. 4. In particular, the method 500 can be performed by a browser, (e.g., browser manager 420) of a computing system 402. At step 502, the system may cause display of a webpage within a display area of a browser. At step 504, the system may receive a selection of an area of the webpage content (e.g., search area SA in FIG. 1A). In response to selection of the search area included in the webpage (506), the system may at step 508 request a search for the content of the search area. The request can include the content of the search area, an identifier of the webpage, and context for the search area from the webpage. In some implementations, the request can include a number of (i.e., a quantity of) related queries to return. The system may provide this request to search the search area to a server, e.g., a search server. The search server may provide a response to the search request. The response can include a searched query, a search result page for the searched query, and at least one related search request. The related search request(s) are additional queries (related queries) that can be submitted by the user from the search result interface (e.g., search result area 150 of FIG. 1B and other figures) without navigating away from the webpage.

At step 510 the system receives the response and at step 512 the system causes display of a first search request indicator and a second search request indicator within a search result area outside of the display area and within the browser. In some implementations, the first search request indicator can represent the searched query and the second search request indicator can represent the related search request. In some implementations, e.g., where two or more related search requests are provided in the response, the first search result indicator can represent one of the related search requests and the second search result indicator can represent another of the related search requests. At step 514 the system receives a selection of the first search request indicator. At step 516 the system, in response to the selection of the first search request indicator, causes display of content for the first search request indicator within a navigation area of the search result area. In implementations where the searched query is represented by the first search request indicator, the content is the search result page received in the response. In such implementations, the display of the content may include automatically maximizing the size of the search result area (e.g., displaying the search result area in a maximized state) so that at least a portion of the search result page for the searched query is visible. In implementations where the first search request indicator represents a related query, the display of the content may include submitting the related query to a search server and receiving a search result page for the related query, and displaying the search result page for the related query.

Once the system renders the search result area, the system may be configured to respond to one or more different inputs related to the search result area. For example, in step 550, the system may receive an interaction (a selection, a tap, a click, etc.) outside of the search result area. In response to the receipt of this interaction, at step 552, the search result area may be closed, or in other words, removed from the display area of the browser. As another example, in step 530 the system may receive a selection of a link in the navigation area (e.g., a selection of a link from the search result page currently displayed in the navigation area of the search result area). Or, in step 530, the system may receive selection of a control in the search result area configured to open the search result page currently displayed in the navigation area to a new tab. In response to receiving the selection of the link or the control, at step 534 the system may create the new tab and display the content of the navigation area (the search result page for the search request in focus) in the new tab.

As another example, at step 540 the system may receive an interaction with a handle of the search result area. The interaction may be a dragging of the handle, which changes a size of the search result area displayed in the browser. The system may monitor the location (coordinates) of the handle during the drag and, at step 542, determine whether the coordinates meet a minimization threshold (e.g., minimization threshold 338 of FIG. 3C). Responsive to determining that a coordinate of the handle does meet the minimization threshold and when the content in the navigation area is not content from the search results for the searched query, at step 544, the system may replace the content in the navigation area with content from the search result page for the searched query, e.g., as illustrated in FIG. 3D.

As another example, at step 520 the system may receive an interaction for (a selection of a particular search request indicator. The particular search request indicator can be any of the search request indicators displayed in the search result area. In response to receiving the selection (522), the system may, at step 524, send the query that corresponds to the particular search request indicator to a search server. At step 526 the system receives, in response to the request, a search result page for the query. At step 528 the system causes display of content from the search result page for the query in the navigation area of the search result area. The query associated with the particular search request indicator may then be considered the current search request or the search request in focus.

FIG. 6 is a flowchart that illustrates a method 600 of performing at least some of the concepts described herein in the various figures. Many elements of the method 600 can be implemented by the components shown in at least FIG. 4. In particular, the method 600 can be performed by a server system (e.g., search server 440). At step 602 the system may receive, from a browser executing on a client device, a request to search a selected search area. The request includes the selected search area and an identifier of a webpage displayed by the browser. The request can include context for the search area. The request can include a quantity of related search requests (related queries) to return. In the request, the selected search area and the context are content from the webpage identified in the request.

At step 604, the system may determine a query for the selected search area. The query may be referred to as the searched query. In determining the searched query, the system may identify several candidate queries for the search area and select a top-ranking query as the searched query. The system may use known or later developed techniques for selecting the searched query. The system may, at step 606, obtain a search result page for the searched query. At step 608. the system may determine one or more related search requests for the search area. These related search requests can also be referred to as candidate related queries. The system may rank the candidate related queries at step 610. The ranking may be dependent on a number of factors, including the identifier of the webpage. The ranking can also or instead use a length of the candidate related queries as a ranking factor. As part of step 610, the system may select highest-ranked candidate related queries. The number of selected candidate queries (related search requests) can be based on the quantity received with the request to search the search area. At step 612, the system provides the query, the selected related search request(s), and the search result page for the query to the browser as a response to the request.

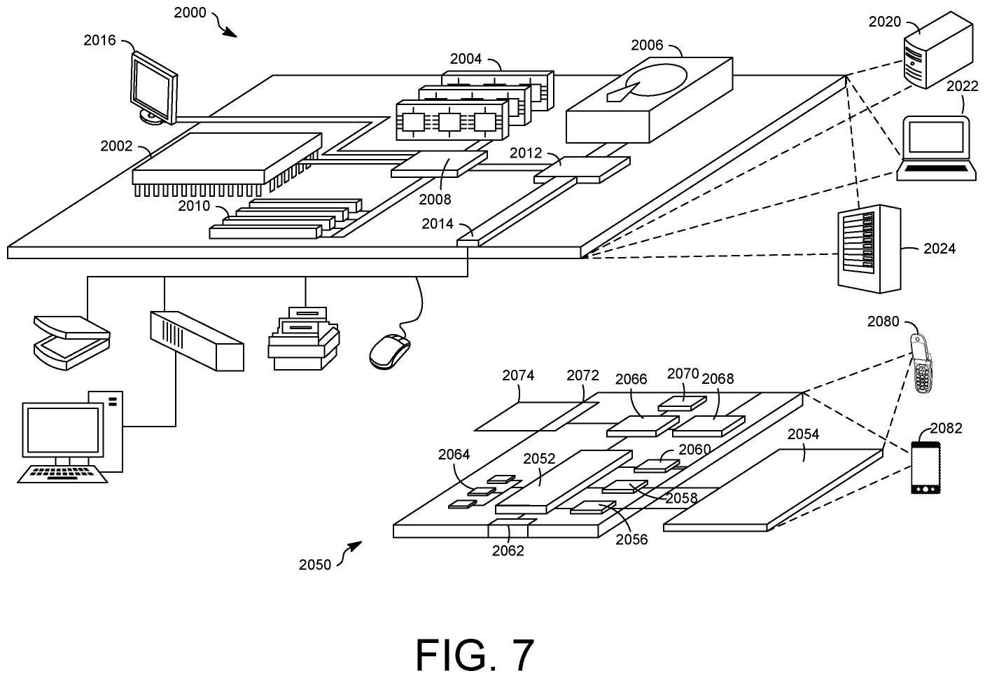

FIG. 7 shows an example of a generic computer device 2000 and a generic mobile computer device 2050, which may be used with the techniques described herein. Computing device 2000 is intended to represent various forms of digital computers, such as laptops, desktops, tablets, workstations, personal digital assistants, televisions, servers, blade servers, mainframes, and other appropriate computing devices. Computing device 2050 is intended to represent various forms of mobile devices, such as personal digital assistants, cellular telephones, smart phones, and other similar computing devices. The components shown here, their connections and relationships, and their functions, are meant to be examples only, and are not meant to limit implementations of the implementations described and/or claimed in this document.

Computing device 2000 includes a processor 2002, memory 2004, a storage device 2006, a high-speed controller 2008 connecting to memory 2004 and high-speed expansion ports 2010, and a low-speed controller 2012 connecting to low speed expansion port 2014 and storage device 2006. The processor 2002 can be a semiconductor-based processor. The memory 2004 can be a semiconductor-based memory. Each of the components 2002, 2004, 2006, 2008, 2010, and 2012, are interconnected using various busses, and may be mounted on a common motherboard or in other manners as appropriate. The processor 2002 can process instructions for execution within the computing device 2000, including instructions stored in the memory 2004 or on the storage device 2006 to display graphical information for a GUI on an external input/output device, such as display 2016 coupled to high-speed controller 2008. In other implementations, multiple processors and/or multiple buses may be used, as appropriate, along with multiple memories and types of memory. Also, multiple computing devices 2000 may be connected, with each device providing portions of the necessary operations (e.g., as a server bank, a group of blade servers, or a multi-processor system).

The memory 2004 stores information within the computing device 2000. In one implementation, the memory 2004 is a volatile memory unit or units. In another implementation, the memory 2004 is a non-volatile memory unit or units. The memory 2004 may also be another form of computer-readable medium, such as a magnetic or optical disk.

The storage device 2006 is capable of providing mass storage for the computing device 2000. In one implementation, the storage device 2006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 2004, the storage device 2006, or memory on processor 2002.

The high-speed controller 2008 manages bandwidth-intensive operations for the computing device 2000, while the low-speed controller 2012 manages lower bandwidth-intensive operations. Such allocation of functions is an example only. In one implementation, the high-speed controller 2008 is coupled to memory 2004, display 2016 (e.g., through a graphics processor or accelerator), and to high-speed expansion ports 2010, which may accept various expansion cards (not shown). In the implementation, low-speed controller 2012 is coupled to storage device 2006 and low speed expansion port 2014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 2000 may be implemented in a number of different forms, as shown in the figure. For example, it may be implemented as a standard server 2020, or multiple times in a group of such servers. It may also be implemented as part of a rack server system 2024. In addition, it may be implemented in a personal computer such as a laptop computer 2022. Alternatively, components from computing device 2000 may be combined with other components in a mobile device (not shown), such as device 2050. Each of such devices may contain one or more of computing device 2000, 2050, and an entire system may be made up of multiple computing devices 2000, 2050 communicating with each other.

Computing device 2050 includes a processor 2052, memory 2064, an input/output device such as a display 2054, a communication interface 2066, and a transceiver 2068, among other components. The device 2050 may also be provided with a storage device, such as a microdrive or other device, to provide additional storage. Each of the components 2052, 2064, 2054, 2066, and 2068, are interconnected using various buses, and several of the components may be mounted on a common motherboard or in other manners as appropriate.

The processor 2052 can execute instructions within the computing device 2050, including instructions stored in the memory 2064. The processor may be implemented as a chipset of chips that include separate and multiple analog and digital processors. The processor may provide, for example, for coordination of the other components of the device 2050, such as control of user interfaces, applications run by device 2050, and wireless communication by device 2050.

Processor 2052 may communicate with a user through control interface 2058 and display interface 2056 coupled to a display 2054. The display 2054 may be, for example, a TFT LCD (Thin-Film-Transistor Liquid Crystal Display) or an OLED (Organic Light Emitting Diode) display, or other appropriate display technology. The display interface 2056 may comprise appropriate circuitry for driving the display 2054 to present graphical and other information to a user. The control interface 2058 may receive commands from a user and convert them for submission to the processor 2052. In addition, an external interface 2062 may be provide in communication with processor 2052, so as to enable near area communication of device 2050 with other devices. External interface 2062 may provide, for example, for wired communication in some implementations, or for wireless communication in other implementations, and multiple interfaces may also be used.

The memory 2064 stores information within the computing device 2050. The memory 2064 can be implemented as one or more of a computer-readable medium or media, a volatile memory unit or units, or a non-volatile memory unit or units. Expansion memory 2074 may also be provided and connected to device 2050 through expansion interface 2072, which may include, for example, a SIMM (Single In Line Memory Module) card interface. Such expansion memory 2074 may provide extra storage space for device 2050, or may also store applications or other information for device 2050. Specifically, expansion memory 2074 may include instructions to carry out or supplement the processes described above, and may include secure information also. Thus, for example, expansion memory 2074 may be provided as a security module for device 2050, and may be programmed with instructions that permit secure use of device 2050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 2064, expansion memory 2074, or memory on processor 2052, that may be received, for example, over transceiver 2068 or external interface 2062.

Device 2050 may communicate wirelessly through communication interface 2066, which may include digital signal processing circuitry where necessary. Communication interface 2066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 2068. In addition, short-range communication may occur, such as using a Bluetooth, WiFi, or other such transceiver (not shown). In addition, GPS (Global Positioning System) receiver module 2070 may provide additional navigation- and location-related wireless data to device 2050, which may be used as appropriate by applications running on device 2050.

Device 2050 may also communicate audibly using audio codec 2060, which may receive spoken information from a user and convert it to usable digital information. Audio codec 2060 may likewise generate audible sound for a user, such as through a speaker, e.g., in a handset of device 2050. Such sound may include sound from voice telephone calls, may include recorded sound (e.g., voice messages, music files, etc.) and may also include sound generated by applications operating on device 2050.

The computing device 2050 may be implemented in a number of different forms, as shown in the figure. For example, it may be implemented as a cellular telephone 2080. It may also be implemented as part of a smart phone 2082, tablet, glasses, smart watch, personal digital assistant, or other similar mobile device.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the disclosed implementations.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

What is claimed is:

1. A method, comprising:
in response to selection of a search area included in a webpage displayed within a display area of a browser:
requesting a search for content of the search area,
receiving a searched query, a search result page for the searched query, and a related search request, and
causing display of a first search request indicator and a second search request indicator within a search result area outside of the display area and within the browser;
receiving a selection of the first search request indicator; and
in response to the selection of the first search request indicator, causing display of content for the first search request indicator within a navigation area of the search result area.

2. The method of claim 1, wherein the request for the search includes the content of the search area and an identifier for the webpage, wherein the related search request is selected based at least in part on the identifier for the webpage.

3. The method of claim 1, wherein the first search request indicator represents the searched query and the content for the first search request indicator is content from the search result page.

4. The method of claim 3, wherein causing display of the content for the first search request indicator includes maximizing the search result area to display the navigation area.

5. The method of claim 4, wherein the search result area, when maximized, occupies more area than the display area.

6. The method of claim 1, wherein the related search request is a first related search request and a second related search request is received with the first related search request, the first search request indicator represents the second related search request, and the method further comprises, in response to selection of the first search request indicator:
requesting a search for the second related search request;
receiving a second search result page for the second related search request; and
causing display of second content in the navigation area, the second content being content from the second search result page.

7. The method of claim 1, wherein the content for the first search request indicator is first content and the method further comprises:
receiving a selection of the second search request indicator; and
in response to receiving the selection of the second search request indicator:
requesting a search for the related search request,
receiving a second search result page for the related search request, and
causing display of second content in the navigation area, the second content being content from the second search result page and the second content replacing the first content in the navigation area.

8. The method of claim 7, wherein the search result area includes a handle configured to change a size of the navigation area and the method further comprises:
receiving an interaction with the handle that changes the size of the navigation area displayed in the search result area;
determining that a coordinate of the handle reaches a minimization threshold; and
in response to determining that the coordinate reaches the minimization threshold, causing display of the first content in the navigation area, the first content replacing the second content in the navigation area.

9. The method of claim 8, further comprising changing a size of the navigation area in response to an interaction with the navigation area.

10. The method of claim 1, the search result area further comprising a query text area, the query text area displaying text related to the content displayed in the navigation area.

11. The method of claim 1, further comprising:
receiving a selection of a link in the content displayed in the navigation area; and
creating a new browser tab from the content.

12. The method of claim 1, wherein the search result area includes a search request area disposed between a query text area and the navigation area, wherein the first search request indicator and the second search request indicator are disposed in the search request area.

13. The method of claim 1, further comprising, in response to selection of the search area:
determining whether the search area is text that is not actionable text;
in response to determining that the search area is text that is not actionable text, performing requesting the search; and
in response to determining that the search area is not text or that the text is actionable text. displaying a pop-up menu that includes actions for the actionable text.

14. The method of claim 1, wherein the searched query is a query generated using the content of the search area and provided to a search engine to generate the search result page.

15. The method of claim 1, wherein the related search request is a query generated using the content of the search area that differs from the searched query.

16. A computing device, comprising:
at least one processor; and
memory storing instructions that, when executed by the at least one processor, cause the computing device to perform operations including:
in response to selection of a search area included in a webpage displayed within a display area of a browser:
requesting a search for content of the search area,
receiving a searched query, a search result page for the searched query, and a related search request, and
causing display of a first search request indicator and a second search request indicator within a search result area outside of the display area and within the browser;
receiving a selection of the first search request indicator; and
in response to the selection of the first search request indicator, causing display of content for the first search request indicator within a navigation area of the search result area.

17. The computing device of claim 16, wherein the first search request indicator represents the searched query and the content for the first search request indicator is content from the search result page.

18. The computing device of claim 16, wherein the related search request is a first related search request and a second related search request is received with the first related search request, the first search request indicator represents the second related search request, and the operations further comprise, in response to selection of the first search request indicator:
requesting a search for the second related search request;
receiving a second search result page for the second related search request; and
causing display of second content in the navigation area, the second content being content from the second search result page.

19. A method, comprising:
receiving, from a browser executing on a client device, a request to search content for a selected search area, the request including the content for the selected search area and an identifier of a webpage displayed by the browser, the selected search area being content included in the webpage;
determining a query for the selected search area;
determining, using the identifier of the webpage, a related search request for the selected search area;
obtaining a search result page for the query; and
providing the query, the related search request, and the search result page as a response to the request.

20. The method of claim 19, wherein as part of determining the related search request the method further includes favoring a shorter related search request over a longer related search request.
